(19) United States
(12) Patent Application Publication
(10) Pub. No.: US 2004/0133740 A1
(43) Pub. Date: Jul. 8, 2004

(54) Computer operating system feature for preserving and accessing prior generations of a data set

(76) Inventor: Lee Prewitt, Mercer Island, WA (US)

Correspondence Address: GRAYBEAL, JACKSON, HALEY LLP, 155 - 108TH AVENUE NE, SUITE 350, BELLEVUE, WA, 98004-5901, US

(21) Appl. No.: 10/686,555

(22) Filed: Oct. 14, 2003

Related U.S. Application Data
(60) Provisional application No. 60/418,146, filed on Oct. 11, 2002.

(51) Int. Cl. G06F 12/00

(52) U.S. Cl. 711/112; 711/4

(57) ABSTRACT

A computer operating system method for use with removable computer memories such as optical disks, including write-once disks and write-many disks, for preserving and allowing access to prior generations of a data set, including any kind of data file. When the system is used with a write-many memory, such as a re-writeable CD, the system functions are limited so that generations of the data set older than the currently open generation cannot be revised, even though the physical media would allow revision if the system did not limit this function. To ensure that data written to a write-many disk cannot easily be revised with commonly available software, the data address table for accessing the data is written in a location that is not recognized by available software and is only recognized by software created in accordance with this invention: specifically, the data address table is written in the highest available sector while new versions of the data set are written in the lowest available sector. A user interface function of the operating system is modified to display an identifier for each generation on a removable memory. A user may select any prior generation and read the data in its condition at the time the prior generation was closed.

### BACKGROUND

For more than 25 years, the most commonly used portable random access memories for computer systems have been magnetic disks. Information is written to a track on the disk with a magnetic head and the same head (or a different head) can subsequently read the information and rewrite (modify) the information. So that information written to various sectors and various tracks can quickly and easily be found, a data address table is written in a sector of the disk that can easily be found. The data address table is commonly called a “file allocation table (FAT)”. If the data within a file is changed without being enlarged, the sectors containing the data may be re-written and no change is required in the data address table. If modification of the file data requires additional sectors, the logical addresses of the additional sectors can be added to the data address table. Again, because each sector of memory can be re-written, (“write-many”) the data address table can remain in its original, easy to find location.

However, when optical disks were first created, they were “write-once” memory devices. Consequently, whenever the data for a sector is changed, an entire new sector must be written containing the data and the data address table must be updated. Because the data address table must be updated, it too must be written in a new sector that has not previously been used. At first, various manufacturers devised different systems for determining the location of each re-written data address table for write-once memories.

The OSTA (the Optical Storage Technology Association) devised the Universal Disk Format (UDF) to ensure some level of compatibility among manufacturers implementing optical disk storage technologies, including DVD, CD-R, CD-RW and other memories that may de designed to be compatible. The key to the UDF file system is the data address table method uses a flexible addressing scheme called the Virtual Allocation Table (VAT). Every file (or sub-part of a large file) written to a recordable disk is assigned a sequential number representing a virtual address. While a packet writing operation might change a file's logical address (actual location) on the disk, the virtual address does not change. A structure within the VAT that defines how files are organized on the disk is called the file entry Information Control Block (ICB). The ICB within the VAT points to the files and directories on the disk. Files located on more than one extent (more than logical address block or sector) can be accessed through a list of extents spanned by the file.

Within the UDF specification, as each packet writing operation takes place, a VAT ICB is written on the very last physical address to be written on the disk where the CD recorder can quickly locate it. Writing to a disk begins with an inner-most (logical lowest) track and sector and continues sequentially across the tracks to logically higher and higher sectors. For all writes except the last write to be put on a disk, the last physical address where the VAT ICB is written becomes a location somewhere in the middle of the disk once it is superceded by a new VAT ICB. Under the UDF method, it is only the last VAT ICB that is of interest. Although the older VAT ICB's are in locations that are difficult to find, the latest VAT ICB can be easily found because it is the most extreme track and sector that has yet been written.

Changes to the file contents and directory structure on a disk can be handled by simply writing a new, revised copy of the material that has changed and writing the actual address information for the newer version to the new VAT ICB which is the last item written on the disk. The UDF system uses the VAT ICB as an interchangeable set of pointers that can be updated whenever necessary to accommodate changing file structures. When a new VAT ICB is written, the old VAT ICBs become irrelevant and there is no system to easily find them.

### SUMMARY

In one embodiment, the invention is a method for organizing data address tables in a memory having sectors ranging from logically lowest to logically highest, such as optical disks. The method can be used for any memory having sectors where the sectors have logical addresses, including write-once memories and write-many memories. In this method, when a first data set is written to the memory, it is written to the lowest available sector(s) of the memory and a data address table which specifies logical locations of the first data set is written in one or more available sectors which are other than the lowest available sectors of the memory. Then, if a second data set is added to the memory, the second data set is written to at least one sector of the memory which is now the lowest available sector and a new (second) data address table which specifies logical locations of the second data set is written in the sector of the memory which, again, is other than the lowest available.

In one embodiment, the data address tables are written to the highest available sectors. Once the first and the second data address tables have been written, a sector of the second data address table will adjoin a sector of the first data address table. The data address tables will be easy to find. The computer is simply instructed to look first at the logically highest sector and then the next highest sector etcetera until a sector that has not been written is found. At this point, all of the data address tables will have been found.

This method may be used for write-once memories such as burnable CDs and DVDs and for write-many memories. When the system is implemented for use with a write-many memory, it can be designed to simulate the use of a write-once memory by failing to carryout any instructions to modify data sets that were recorded to the memory in prior sessions. This is useful for creating archive records. If the record is created with a write-once memory, there is no risk of subsequent modification of the record. Similarly, if the archive record is created with a write-many memory, it will be difficult for an ordinary user using the ordinarily available tools to modify the archive record.

Once computer memories have been created with such an archive record, users require computer programs which allow easy access to the records. Although an application computer program could easily be written which allows access to the archived records, this would be inadequate to meet the preferences of most users. Generally, users want to have access to any memory via the user interface and features of the computer operating system without having to obtain and launch a special application. All operating systems include user interfaces and access features for listing on a display screen all of the available contents of a magnetic disk or similar re-writeable memory. The users also need a means for accessing the prior and subsequent generations of data saved in a memory such as the archive records discussed above.

In another embodiment, the invention is a method for allowing access through a computer operating system user interface to prior and subsequent generations of data saved in a memory. According to this method, a first generation set of data and a first data address table specifying at least one location of the set of data are each saved to a memory. Then, when new data for modifying the first generation set of data is received, the new data is added to the memory while leaving the first generation set of data unchanged. A second data address table specifying at least one location of the new data is also recorded in the memory. Then, with an operating system modified according to the present invention, the user is presented with a user interface accessible via a user interface function of the operating system. The user interface displays identifiers of both the first generation data set and a second generation data set resulting from the first generation data set as modified by the new data. One or more of the identifiers may be selected by a user using a feature of the operating systems such as a cursor on the screen controlled by a mouse. If the computer receives a selection of the second generation data set, the computer reads the data of the second generation data set, including data elements of the original data set, according to address locations specified, at least in part, by the second data address table. This method is effective whether the new data adds to the first generation data set without replacing data of the first generation data set or whether the new data replaces a portion of the first generation data set, including situations where the new data replaces a portion of the first generation data set with null data (an indicator that no data is found at this data address).

This method may be implemented in Windows operating systems by installing a driver which modifies the user interface screen display for the “Properties” function of the Windows operating system. Within a Windows operating system, this function may be applied to any memory that is mounted for access by the computer system.

As described above, this method may be used with a write-once memory or a write-many memory. When used with a write-many memory, the method may include a feature that fails to carryout any instruction to modify a generation set of data that is not the latest generation of data.

These and various other features as well as advantages of the present invention will be apparent from a reading of the following detailed description and a review of the associated drawings.

### BRIEF DESCRIPTION OF THE DRAWINGS

The features of the present invention which are believed to be novel are set forth with particularity in the appended claims. Aspects of the invention, together with further objects and advantages thereof, may best be understood by making reference to the following description taken in conjunction with the accompanying drawings wherein:

FIG. 1 shows an operating system computer screen display window presenting an identifier for each of many generations of a data set where any identifier may be selected by a user for reading by the system.

FIG. 2 shows an overview of the file system computer program modules for implementing the invention.

FIG. 3 shows the standard prior art core UDF engine.

FIG. 4 shows the way in which the core UDF engine is modified for an embodiment of the invention.

FIG. 5 shows the layout of a memory according to the standard UDF system.

FIG. 6 shows the preferred method for locating the VAT information control blocks.

### DETAILED DESCRIPTION

In the following detailed description of exemplary embodiments of the invention, reference is made to the accompanying drawings. The detailed description and the drawings illustrate specific exemplary embodiments by which the invention may be practiced. Other embodiments may be utilized, and other changes may be made, without departing from the spirit or scope of the present invention. The following detailed description is therefore not to be taken in a limiting sense, and the scope of the present invention is defined by the stated claims.

The invention encompasses computer methods, computer programs on program carriers (such as disks or signals on computer networks) that, when run on a computer implement the method, and computer systems with such a program installed for implementing the method. The various embodiments of the invention may be implemented as a sequence of computer implemented steps or program modules organized in any of many possible configurations. The implementation is a matter of choice dependent on the performance requirements of the computing system implementing the invention. One embodiment of the invention is based on the method (defined by the Optical Storage Technology Association, OSTA, in their UDF specifications revision 1.50 and higher) of virtual addressing for write-once media. In this method, there is a table called the Virtual Allocation Table (VAT) written to the disk before the disk is removed at the end of each session or at any time the file system decides to check point the disk such as on the close of a file. Writing the VAT establishes a complete record of the “contents” of the disk at that point in time, which we refer to as a “generation”. This table provides indirect addressing to the data structures of each file and directory. In other words, any file or directory can be accessed by an address that is always constant; the VAT translates this into the address on the disk of the most recent version of that file or directory. Thus the appearance from the outside is that a single copy of a given file is being updated on the disk, while the reality is that newer and newer separate copies of the file are being presented to the outside world. The “contents” of the disk as presented to a user consist of only the most recently saved version of a file and not the previously saved versions of the file which are also on the disk but not intended to be read.

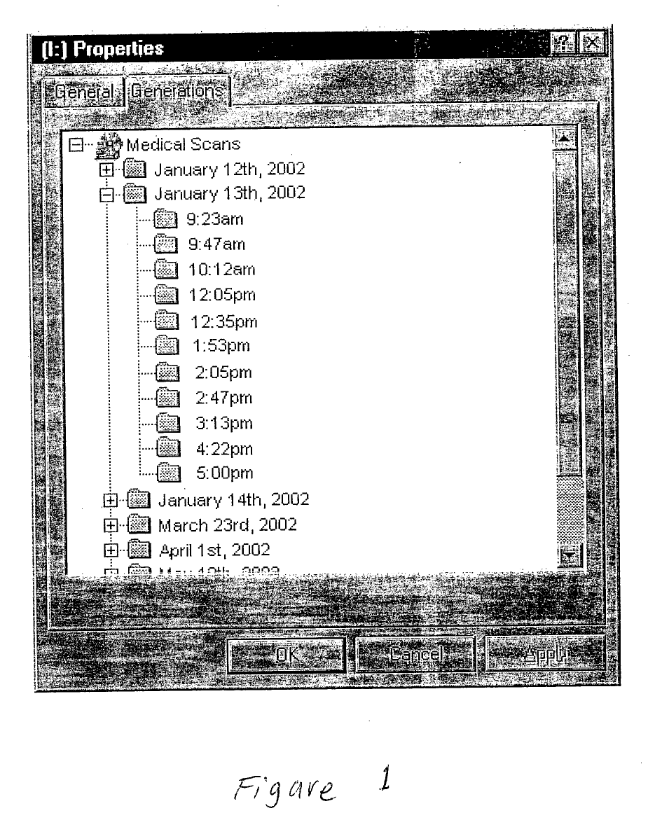

An embodiment of the invention supplies a simple user interface as a feature of the operating system that is viewable in any Windows compatible program to allow the user to view the different generations of the contents of the disk as shown in FIG. 1. Each generation is like a snapshot of the disk at the moment that generation was “closed”—i.e., when the disk was ejected. Only the highest generation is allowed to be writable (which requires making a new copy if it has been “closed”); all earlier generations are locked to be read only. This provides a secure audit trail of changes on the disk.

In the user interface display, the first view of the identifiers of various versions may be presented either in a file by file view on in a session by session view for the entire memory. FIG. 1 shows the session by session view. For January 13^{th}, eleven sessions are shown, each identified by the time it was saved to the memory. If any one of these identifiers is selected by a user, the state of all files on the memory will be presented to the user as they were at that time. In this method, the user right clicks on the icon of the drive itself under My Computer and gets a list of the session by session generations of the disk. This view rolls back the entire disk to the state that the disk was in at the given date and time.

For the file by file view, the user interface can be configured instead to show a list of all files on the memory in its then selected state and, associated with each file, a list of times, both before and after the then present state being accessed, when that file was modified and saved. The user can then select any other time and see the file in the state it was in at that time without seeing identifiers for other files on the screen at the same time. In this method, the user right clicks on the icon of the file and gets a list of the generations of that file only. This view rolls back only the chosen file to the state that the file was in at the given date and time. If a file has been deleted, the only was to access it is by starting from a session in which it existed.

When the invention is used with true physically write-once media such as CD-R or DVD-R, it provides a history of changes that is very hard to falsify. This provides a valuable system for record keeping where data can be revised and a record of each version should be maintained. Each version or generation of the data can be easily accessed by a user using an extension of the operating system in the “Properties” window for the disk, as shown in FIG. 1.

For applications where security is less of an issue, the invented system can also be used in much the same way on rewritable (write-many) media. Here it provides exactly the same history of changes. The security tradeoff is that the disks can be reused. Because the invented software includes a lock feature, it is very difficult to alter specific files or generations, but, with other common software, the entire disk could be erased, for example. With one embodiment of the system, it is difficult to modify a file using common software because the VAT is not placed in the usual location where common software would expect to find it. The usual place is in the last written address at the end of a session. Offsetting the VAT location from the standard location prevents the disk from being mounted in a disk drive run with common software, thereby making modification very difficult without special software and computer systems expertise. The VAT may be offset to any other location where software designed according to this invention may find it. The preferred location is in the highest available sector(s).

The invented system builds on the OSTA UDF concept of a series of VATs, shaping it into the concept of “generations” showing the history of files on a disk and making those generations viewable through the Windows Explorer GUI (graphical user interface) in an easy to use manner, as shown in FIG. 1. The user can easily go back through the various generations of a specific file.

The invented system can be implemented within a computer software application or within an operating system level utility or driver. The software to implement the system can be provided to the user on the writable (write-once) or rewritable (write-many) media that the user is planning to use for saving the various generations.

Once an optical disk or other memory organized with sectors having logical addresses has been formatted using this invention, it can be used in any optical disk drive or system designed to read such physical types of media, as part of a computer system, consumer electronics device, medical imaging system, backup or archival systems or other industrial systems utilizing the recording of data on a storage device.

The invented method of allowing access through a computer operating system user interface to prior and subsequent generations of data saved in a memory can be implemented with any VAT location method, including the UDF system. However, for use with rewritable media, it is important to change the VAT location so that the prior generations can not be modified with commonly available software. To do this, we locate the VATs starting at the logically highest sector of the disk and use progressively lower sectors for each generation. This is very different from the scheme used on DVD-R/CD-R where data is recorded sequentially and the VAT is at the highest recorded sector of each session (generation). This allows for relatively secure archiveability on cheap rewritable disks like using WORM (write-once read-many) memories. For compatibility with WORM disks written with the invented software, one embodiment of the invention uses this same VAT location system for WORM disks as well.

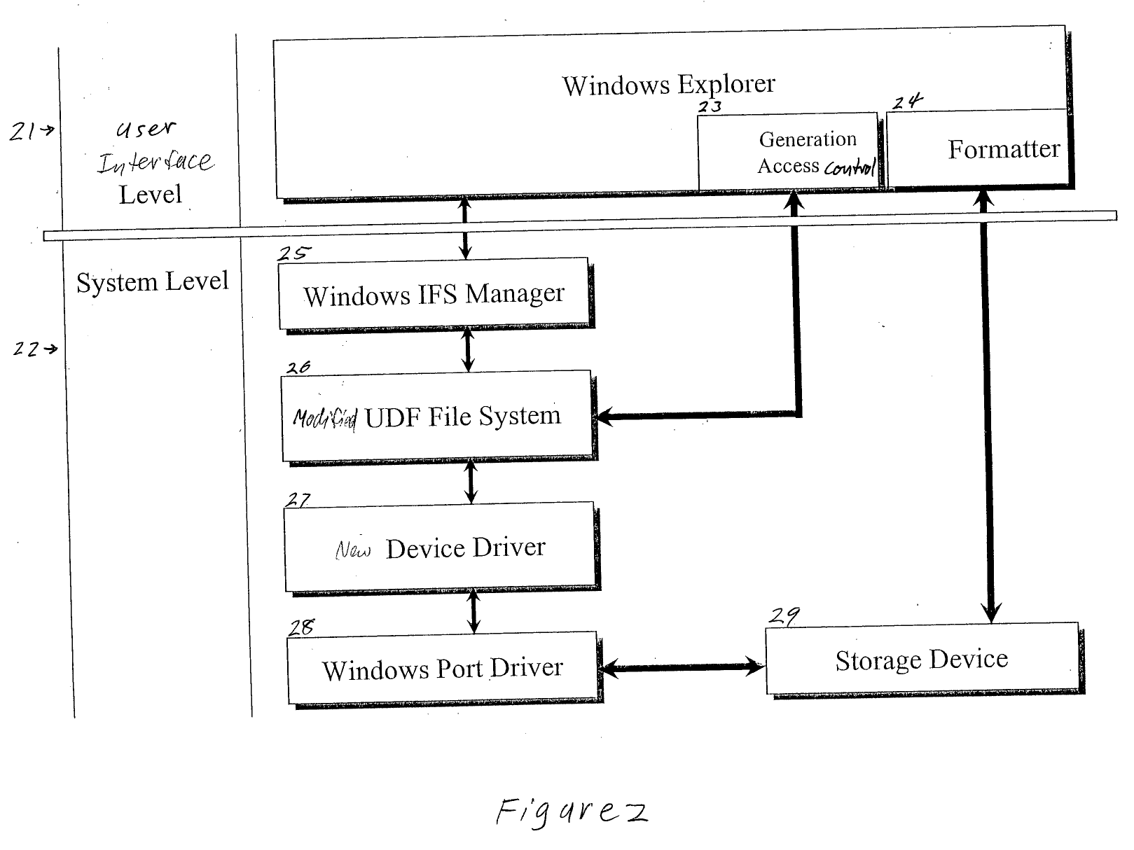

FIG. 2 shows an overview of the file system computer program modules for implementing the invention. The operating system software may be conceptually categorized into user interface level software 21 and system level software 22. In the Windows operating system, Windows Explorer is an operating software component operating at the user interface level. In an embodiment of the invention, two additional functions are added into the user interface level as show in FIG. 2, a generation access control 23 and a formatter 24. These controls give the user an easy to use interface for accessing the generations of contents on the memory as shown in FIG. 1 and for formatting the memory to work with the invented system.

When implemented for a Windows operating system, the important system level components are shown in FIG. 2. The Windows IFS manager 25 is unchanged. The UDF file system 26 is modified in a way that is described below. The device driver 27 is replaced with a new device driver for implementing the invented method. The Windows port driver is unchanged. The Windows port driver 28 and the formatter 24 both work directly with the storage device 29.

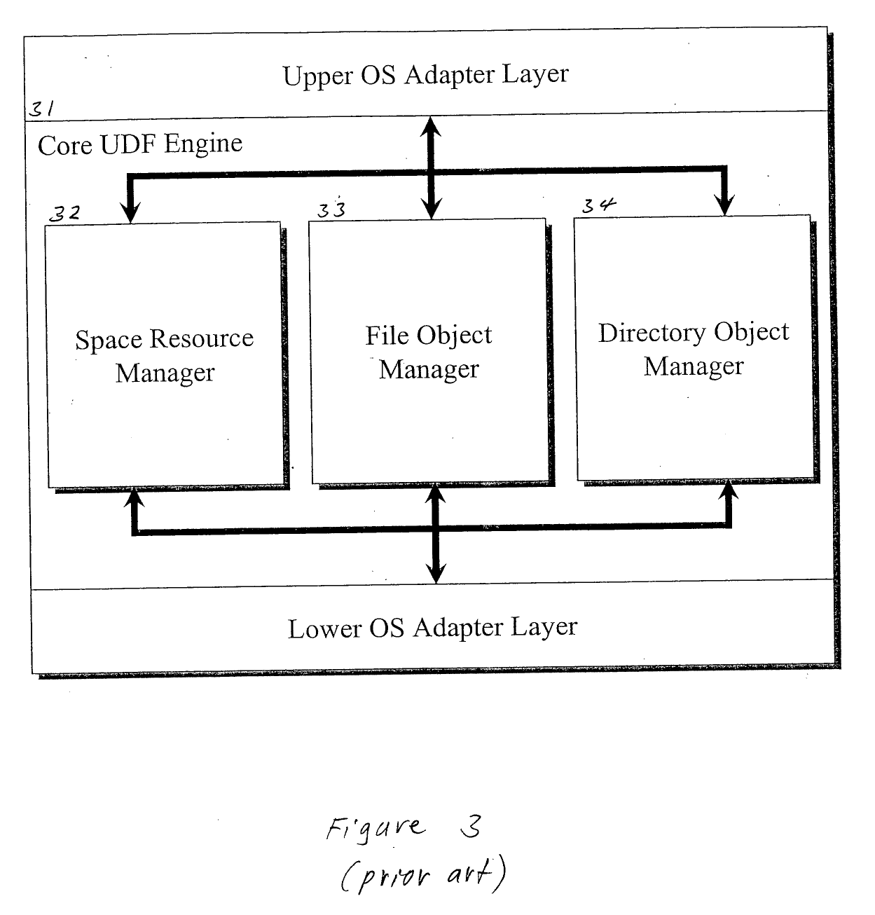

The standard prior art core UDF engine 31 is shown in FIG. 3. Its modules include a space resource manager 32, a file object manager 33, and a directory object manager 34.

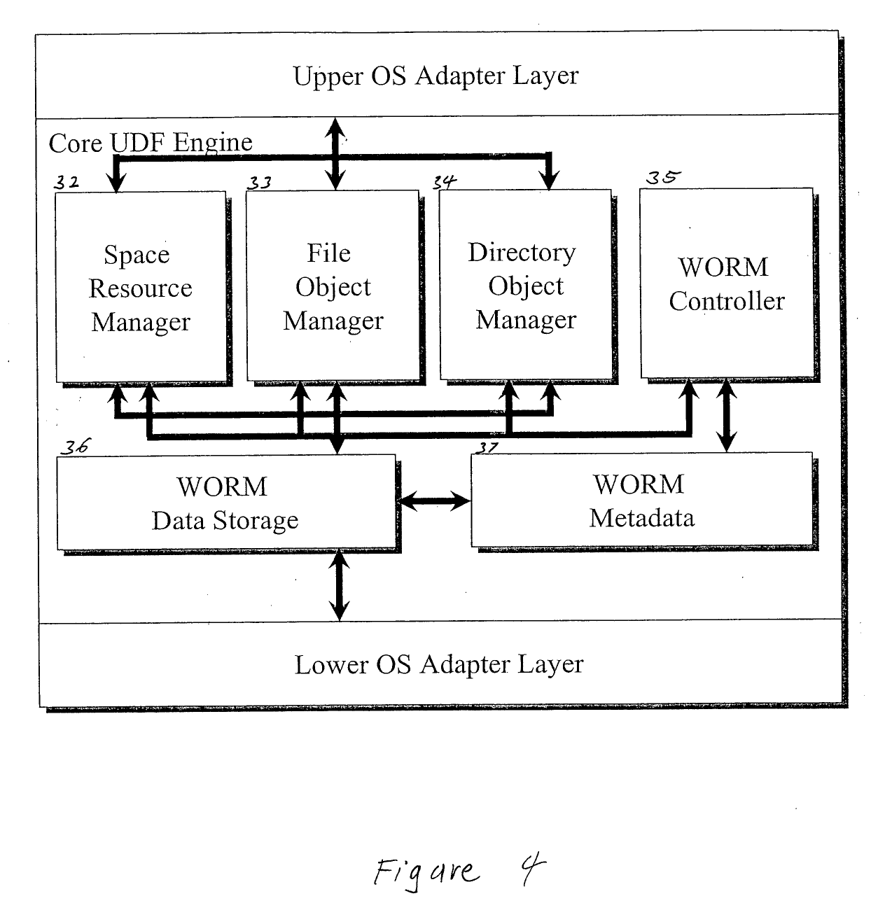

The way in which the core UDF engine is modified for an embodiment of the invention is shown in FIG. 4. In addition to the three modules described above, three additional modules are added to mediate communications between the three original modules and the lower operating system adaptor layer which communicates with the storage device. The three additional modules are a WORM (write-once read-many) controller 35, a WORM data storage module 36, and a WORM meta data module 37. The modules communicate with each other as shown in FIG. 4. These modules implement the relocation of the VAT as discussed above and the restrictions on ability to re-write data that has been written to a write-once memory in a prior generation.

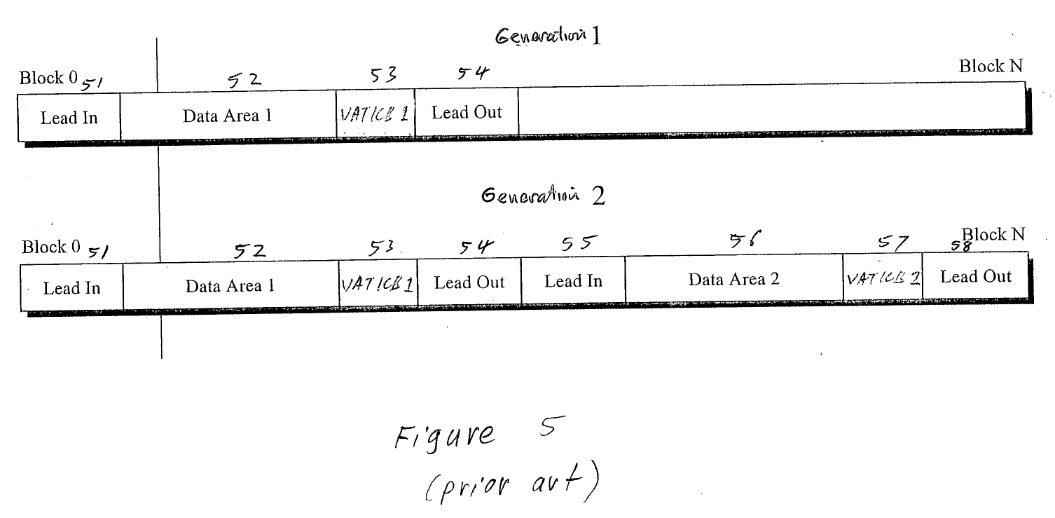

FIG. 5 shows the layout of a memory according to the standard UDF system. After a lead-in block 51, the first data set (first generation) is written in the logically lowest available blocks (sectors) as indicated by data area 1 52. When the data is entirely written and the disk or other memory is to be checkpointed or unmounted, a first VAT information control block 53 is written in the lowest available sector and a lead-out block 54 is written to follow that. Then, when a second data set is added to the disk, such as by modifying or adding to the original data set, a lead-in block 55 is written in the lowest available sector, followed by the new data set 56. Then when the memory is to be checkpointed or unmounted, a second VAT information control block 57 is written in the lowest available sector, followed by a lead-out block 58. The second VAT ICB 57 functionally replaces the first VAT ICB 53.

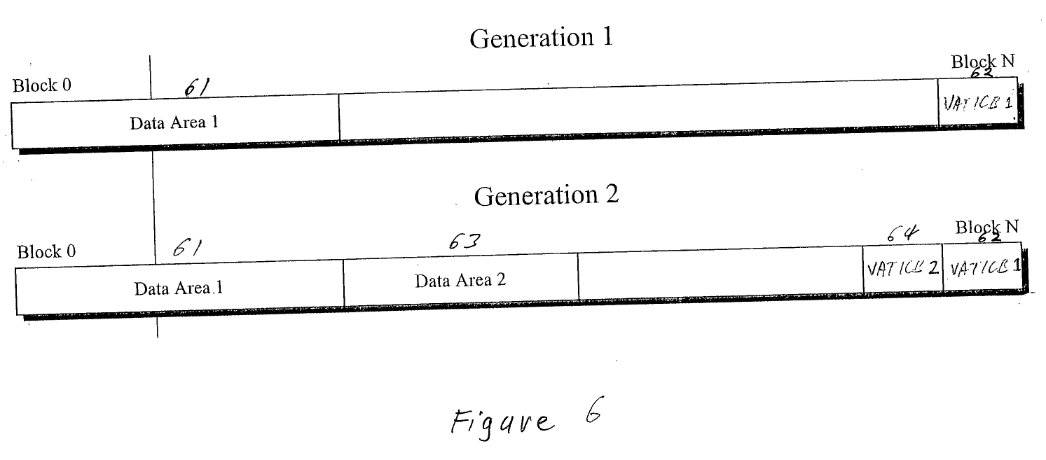

The preferred method for locating the VAT information control blocks for block addressable write once media and on write-many media is shown in FIG. 6. For block addressable write-once media and on write-many media, the lead-in blocks and lead-out blocks are omitted. The first data set written to the disk is written in the lowest available sectors 61 and, when the disk is to be checkpointed or unmounted, a first VAT ICB 62 is written in the highest available sector(s). Then, when a second data set is written to the disk, it is written in the lowest available sectors 63. When the disk is to be checkpointed or unmounted, a second VAT ICB 64 is written in the highest available sectors, which are sectors that adjoin the sectors used for the prior VAT ICB 62.

Although the present invention has been described in considerable detail with reference to certain preferred embodiments, other embodiments are possible. Therefore, the spirit or scope of the appended claims should not be limited to the description of the embodiments contained herein. It is intended that the invention resides in the claims hereinafter appended.

I claim:

1. A computer method for allowing access through a computer operating system user interface to prior and subsequent generations of data saved in a memory, comprising:
(a) saving in a memory a first generation set of data and a first data address table specifying at least one location of the set of data in the memory;
(b) receiving new data with which to modify the first generation set of data;
(c) adding the new data to the memory while leaving the first generation set of data unchanged and saving in the memory a second data address table specifying at least one location of the new data; and
(d) with a user interface accessible via a user interface function of the operating system of the computer, displaying identifiers of both the first generation data set and a second generation data set resulting from the first generation data set as modified by the new data which identifiers may by selected by a user using a feature of the operating system.

2. A computer readable carrier containing computer program instructions which, when run on a computer, cause the computer to perform the method of claim 1.

3. The method of claim 1 further comprising, receiving a selection of the second generation data set and then reading the data of the second generation data set, including at least one data element of the original data set, according to address locations specified by at least the second data address table.

4. A computer readable carrier containing computer program instructions which, when run on a computer, cause the computer to perform the method of claim 3.

5. The method of claim 1 where the new data adds to the first generation data set without replacing data of the first generation data set.

6. A computer readable carrier containing computer program instructions which, when run on a computer, cause the computer to perform the method of claim 5.

7. The method of claim 1 where the new data replaces at least a portion of the first generation data set.

8. A computer readable carrier containing computer program instructions which, when run on a computer, cause the computer to perform the method of claim 7.

9. The method of claim 7 where the new data replaces at least a portion of the first generation data set with null data.

10. A computer readable carrier containing computer program instructions which, when run on a computer, cause the computer to perform the method of claim 9.

11. The method of claim 1 where the operating system is a Windows operating system.

12. A computer readable carrier containing computer program instructions which, when run on a computer, cause the computer to perform the method of claim 11.

13. The method of claim 12 where the user interface function of the operating system is a Properties function with respect to the memory.

14. A computer readable carrier containing computer program instructions which, when run on a computer, cause the computer to perform the method of claim 13.

15. The method of claim 1 where the memory is a write-once memory.

16. The method of claim 1 where the memory is a write-many memory.

17. The method of claim 16 further comprising:
(e) if an instruction is received to modify the first generation set of data, failing to carry out the instruction.

18. A computer readable carrier containing computer program instructions which, when run on a computer, cause the computer to perform the method of claim 17.

19. A computer method for organizing data address tables in a memory having sectors ranging from logically lowest to logically highest, comprising:
(a) when writing a first data set to a memory having sectors, writing the data set to at least one lowest available sector of the memory; and
(b) writing a first data address table which specifies logical locations of the first data set to at least one sector other than the lowest available sector of the memory.

20. A computer readable carrier containing computer program instructions which, when run on a computer, cause the computer to perform the method of claim 19.

21. The method of claim 19 further comprising:
(c) without changing the data of the first data set, writing a second data set to at least one lowest available sector of the memory; and
(d) writing a second data address table which specifies logical locations of the second data set to at least one sector other than the lowest available sector of the memory.

22. A computer readable carrier containing computer program instructions which, when run on a computer, cause the computer to perform the method of claim 21.

23. The method of claim 19 where the one or more sectors to which the first data address table is written are the highest available sectors.

24. A computer readable carrier containing computer program instructions which, when run on a computer, cause the computer to perform the method of claim 23.

25. The method of claim 19 where the memory is a write-once memory.

26. A computer readable carrier containing computer program instructions which, when run on a computer, cause the computer to perform the method of claim 25.

27. The method of claim 19 where the memory is a write-many memory.

28. A computer readable carrier containing computer program instructions which, when run on a computer, cause the computer to perform the method of claim 27.

29. The method of claim 27 further comprising:
(e) if an instruction is received to modify the first data set, failing to carry out the instruction.

30. A computer readable carrier containing computer program instructions which, when run on a computer, cause the computer to perform the method of claim 29.
